(19) United States
(12) Patent Application Publication
(10) Pub. No.: US 2026/0088516 A1
(43) Pub. Date: Mar. 26, 2026

(54) INTELLIGENT ARRANGEMENT METHOD FOR ARRAY ANTENNA ELEMENTS AND OPTIMIZATION METHOD BASED ON CLUSTERING EPIGENETICS

(71) Applicants: Qingdao Agricultural University, Qingdao (CN); Shenzhen Institute for Advanced Study, UESTC, Shenzhen (CN)

(72) Inventors: Lin LI, Qingdao (CN); Yun LI, Qingdao (CN); Jiang XIAO, Qingdao (CN)

(21) Appl. No.: 19/407,554

(22) Filed: Dec. 3, 2025

Related U.S. Application Data
(63) Continuation of application No. PCT/CN2024/080622, filed on Mar. 7, 2024.

(30) Foreign Application Priority Data
Nov. 23, 2023 (CN) 202311572031.X

(51) Int. Cl. H01Q 21/00; G06F 30/27; G06F 111/06; G06N 3/126

(52) U.S. Cl. CPC H01Q 21/0087; G06F 30/27; G06N 3/126; G06F 2111/06

(57) ABSTRACT

An intelligent arrangement method for array antenna elements includes encoding the J_K array and initializing the epigenetic algorithm: generating J+K genes. The present application uses a clustering algorithm in machine learning to divide the population into subpopulations with different characteristics; some individuals in each category perform adaptive learning, and carry out inheritance operations based on epigenetics according to the probability of the fitness of the population individuals. Subsequently, a small number of random mutation operations are performed to generate new subpopulations.

### CROSS-REFERENCE TO RELATED APPLICATIONS

This application is a continuation of International Application No. PCT/CN2024/080622, filed on Mar. 7, 2024, which claims priority to Chinese Patent Application No. 202311572031.X, filed on Nov. 23, 2023, the entire disclosures of which are incorporated herein by reference.

### TECHNICAL FIELD

The present application relates to the technical field of artificial intelligence for antenna array deployment, in particular to an intelligent arrangement method for array antenna elements and an optimization method based on clustering epigenetics.

### BACKGROUND

In recent years, the industrial application of artificial intelligence has developed rapidly, including its application in the optimal design of array antenna element arrangement. Compared with uniform rectangular two-dimensional array antennas, L-shaped array antennas have advantages such as simple structure and good deployment effect, but their direct beamforming pattern performance is poor. Due to the small number of elements, their angle measurement resolution and angle measurement accuracy require intelligent optimal design. Therefore, the optimal arrangement of L-shaped arrays is very important for beamforming and the usability of beam patterns. Through the intelligent optimal deployment of L-shaped arrays, the advantages of simple structure and a small number of elements of L-shaped arrays can be further enhanced, and the disadvantages of L-shaped arrays can also be improved, that is, the performance of their beamforming patterns can be optimized.

In the existing technology, the relevant authorized patent “A New Planar Molecular Array Antenna Synthesis Deployment Method Based on Improved Genetic Algorithm (CN106099393B)” and the previously authorized patent of this application “An Element Arrangement Method for L-shaped Array Antennas Based on Acquired Inheritance (CN107275801B)” have improved the optimization methods and results, including the angle measurement resolution and angle measurement accuracy of beam patterns. However, the existing patent methods are still prone to shortcomings such as premature convergence, resulting in the element arrangement results of the obtained array antennas not reaching the global optimum, and thus their beamforming and beam pattern optimization methods cannot exert stable optimal effects. In order to improve the overall optimization ability and local optimization ability of intelligent optimization algorithms, most current schemes choose to combine two algorithms, such as combining genetic algorithm with simulated annealing algorithm. Although optimization through more than two algorithms can achieve relatively good results, the existing technical methods have problems such as large computational load and slow optimization speed, and their global search ability and local search ability need to be further improved. Therefore, the intelligent arrangement method and system for array antennas need to be improved.

### SUMMARY

The present application provides an intelligent arrangement method for array antenna elements and an optimization method based on clustering epigenetics to address the problems in the existing technology.

To solve the above technical problems, the present application adopts the following technical solutions:

An intelligent arrangement method for array antenna elements, a J_K array that refers to an L-shaped array antenna where numbers of elements in two adjacent boundary columns are J and K respectively, includes:

S1. encoding the J_K array and initializing the epigenetic algorithm: treating the J_K array as a chromosome, when forming a genes of an individual, representing the J_K array using J+K randomly generated binary strings; wherein a number of bits of each binary string is Na, and each binary string is called a gene on a chromosome; each binary string represents an element spacing between a current element and a previous one, and J+K genes are generated using an above method;
S2. determining hyperparameters to be optimized and generating L hyperparameter genes;
S3. saving current J+K+L genes as an initial population of a genetic algorithm; for convenience of expression, denoting a total number of genes in the chromosome (J+K+L) as d, so d=J+K+L;
S4. denoting each chromosome as

$${P}_{k}^{i} ;$$

a gene string of consists of

$${P}_{k}^{i}$$

consists of

$$\{ {x}_{k}^{1} ( i ) , {x}_{k}^{2} ( i ) , … , {x}_{k}^{d} ( i ) \} ,$$

expressed as

$${P}_{k}^{i} = \{ {x}_{k}^{j} ( i ) , i = 1 , … , {N}_{G} , j = 1 , … d \} , where {x}_{k}^{j} ( i )$$

represents a gene and j represents a sequence number of the gene in the chromosome; a population

$${G}_{k} = \{ {P}_{k}^{i} , i = 1 , 2 … , {N}_{G} \} ,$$

where k is a generation of population evolution, i is the sequence number of the chromosome in the population, and N_{G} is a population size;
S5. adjusting an initial population Gₖ once, then calculating a fitness of each chromosome

$${P}_{k}^{i}$$

in the population Gₖ to obtain Fᵢ;
S6. using a clustering algorithm to divide Gₖ into K different subpopulations, selecting an optimal individual from each subpopulation for adaptive learning, and updating the fitness;
S7. performing epigenetic operations to obtain an offspring

$${G}_{k}^{′} ;$$

S8. randomly selecting M parent individuals

$${P}_{k}^{i} = \{ {x}_{k}^{j} ( i ) , i = 1 , … , M , j = 1 , … d \} ,$$

and calculating a fitness proportion p of each parent as

$$p = \frac{{F}_{1}}{{\sum }_{i = 1}^{M} {F}_{i}} ;$$

setting j=1;
S9. the M parent individuals constructing a current gene pool

$${X}^{j} = \{ {x}_{k}^{j} ( 1 ) , {x}_{k}^{J} ( 2 ) , … , {x}_{k}^{j} ( M ) \} ;$$

S10. based on the fitness proportion p of each parent individual, selecting the gene

$${x}_{k}^{j} ( n ) , n ∈ [ 1 , M ]$$

using roulette selection, where individuals with higher proportions have a higher probability of their current genes being selected;

S11. writing

$${x}_{k}^{j} ( n )$$

into a corresponding gene position of the offspring \hat{P}ₖ;
S12. setting j=j+1;
S13. repeating steps S8˜S12 until j=d;
S14. generating an offspring individual

$${\hat{P}}_{k} = \{ {x}_{k}^{j} , j = 1 , … d \} ;$$

S15. repeating steps S8˜S14 N_{G} times to obtain a temporary new population Gk′;
S16. performing mutation operations according to a mutation probability pₘ to generate a new population Gₖ₊₁;
S17. calculating hyperparameter genes of each chromosome in the population Gₖ₊₁ to update the algorithm hyperparameters, and computing a fitness of an updated population;
S18. repeating iterative steps S6˜S17 until a preset termination condition is met, obtaining multiple optimal populations; and
S19. according to different scenarios and requirements, outputting one required optimal population gene and decoding into an element arrangement of a L-shaped array antenna.

In one embodiment, an adjustment in step S5 includes converting binary strings into decimal numbers.

In one embodiment, the adjustment method for adjusting the initial population in step S5 is as follows:
converting the J+K binary strings of each generation into decimal numbers, a value of a decimal number obtained by converting the binary string corresponds to the element spacing between the current element and the previous one, that is, an element spacing D is obtained by restoring the binary string;
when calculating positions of first J elements, counting each generated element spacing D and accumulating to calculate an overall aperture value, if an accumulated value of the element spacing D is about to exceed a maximum array aperture Da, compulsorily adjusting the element spacing of subsequent elements to 1; and
the adjustment method for the latter K elements is the same as that for the first J elements.

In one embodiment, the maximum array aperture Da is 57˜65.

In one embodiment, the preset termination condition in step S18 includes that a change in the fitness of the optimal individual does not exceed 10-6 and/or a preset maximum number of simulations is reached.

The present application also provides an optimization method based on clustering epigenetics, which includes:

A1. denoting a total number of genes in a chromosome (J+K+L) as d, so d=J+K+L;

A2. denoting each chromosome as

$${P}_{k}^{i} ;$$

a gene string of

$${P}_{k}^{i}$$

consists of

$$\{ {x}_{k}^{1} ( i ) , {x}_{k}^{2} ( i ) , … , {x}_{k}^{d} ( i ) \} ,$$

expressed as

$${P}_{k}^{i} = \{ {x}_{k}^{j} ( i ) , i = 1 , … , {N}_{G} , j = 1 , … d \} , where {x}_{k}^{j} ( i )$$

represents a gene and j represents a sequence number of the gene in the chromosome; a population

$${G}_{k} = \{ {P}_{k}^{i} , i = 1 , 2 … , {N}_{G} \} ,$$

where k is a generation of population evolution, i is the sequence number of the chromosome in the population, and N_{G} is a population size;

A3. adjusting an initial population Gₖ once, then calculating a fitness of each chromosome

$${P}_{k}^{i}$$

in the population Gₖ to obtain Fᵢ;
A4. using a clustering algorithm to divide Gₖ into K different subpopulations, selecting an optimal individual from each subpopulation for adaptive learning, and updating the fitness;
A5. performing epigenetic operations to obtain an offspring

$${G}_{k}^{′} ;$$

A6. randomly selecting M parent individuals

$${P}_{k}^{i} = \{ {x}_{k}^{j} ( i ) , i = 1 , … , M , j = 1 , … d \} ,$$

and calculating a fitness proportion p of each parent as

$$p = \frac{{F}_{i}}{{\sum }_{i = 1}^{M} {F}_{i}} ;$$

setting j=1;
A7. the M parent individuals constructing a current gene pool

$${X}^{j} = \{ {x}_{k}^{j} ( 1 ) , {x}_{k}^{j} ( 2 ) , … , {x}_{k}^{j} ( M ) \} ;$$

A8. based on the fitness proportion p of each parent individual, selecting the gene

$${x}_{k}^{j} ( n ) , n ∈ [ 1 , M ]$$

using roulette selection, wherein individuals with higher proportions have a higher probability of their current genes being selected;
A9. writing

$${x}_{k}^{j} ( n )$$

into a corresponding gene position of the offspring \hat{P}ₖ;
A10. setting j=j+1;
A11. repeating steps A6˜A10 until j=d;
A12. generating an offspring individual

$${\hat{P}}_{k} = \{ {x}_{k}^{j} , j = 1 , … d \} ;$$

A13. repeating steps A6˜A12 N_{G} times to obtain a temporary new population Gk′;
A14. performing mutation operations according to a mutation probability p to generate a new population Gₖ₊₁;
A15. calculating hyperparameter genes of each chromosome in the population Gₖ₊₁ to update the algorithm hyperparameters, and computing a fitness of an updated population; and
A16. repeating iterative steps A4˜A15 until a preset termination condition is met, obtaining multiple optimal populations.

### Advantages of the Present Application

The present application first encodes the J_K array of the L-shaped array antenna to randomly generate an initial population. Then, it calculates the fitness value of each individual in the array population to be optimized, and uses a clustering algorithm in machine learning to divide the population into subpopulations with different characteristics. Some individuals in each category perform adaptive learning, and inheritance operations based on epigenetics are carried out according to the probability of the fitness of the population individuals. Subsequently, a small number of random mutation operations are performed to generate new subpopulations. Algorithm hyperparameters such as population size and mutation probability participate in the evolution of individual genes and adaptively change according to the evolutionary state. The above operations are repeated iteratively until the preset stop condition is met, obtaining multiple optimal subpopulations. Then, the user outputs the optimal element arrangement of the L-shaped array antenna according to different required application scenarios. The present application has prominent intelligent arrangement characteristics and significant progress in antenna performance, solving the problems of slow convergence speed and poor obtained results in the optimization process of the arrangement algorithm of the current L-shaped array antenna system, and is applicable to the element arrangement setting of L-shaped and other array antennas.

### BRIEF DESCRIPTIONS OF THE DRAWINGS

FIG. 1 is a flowchart of an intelligent arrangement method for array antenna elements according to the present application.

FIG. 2(a)-(c) are diagrams showing that the clustering epigenetic algorithm of the present application converges to multiple optimal solutions.

FIG. 3 is a mixed encoding diagram of algorithm parameters and hyperparameters of the clustering epigenetics according to the present application.

FIG. 4 is a diagram of epigenetic operations.

FIG. 5 is a comparison diagram of the convergence speed between the clustering epigenetic algorithm of the present application and the acquired genetic algorithm of the existing patent (CN107275801B).

### DETAILED DESCRIPTIONS OF EMBODIMENTS

To facilitate understanding by those skilled in the art, the present application will be further described below in conjunction with embodiments and the accompanying drawings. The content mentioned in the implementation modes is not intended to limit the present application. The present application will be described in detail below with reference to the accompanying drawings.

### Embodiment 1

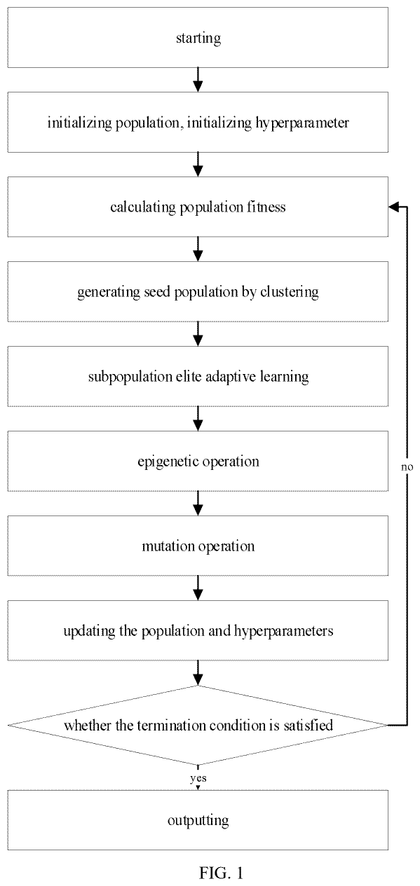

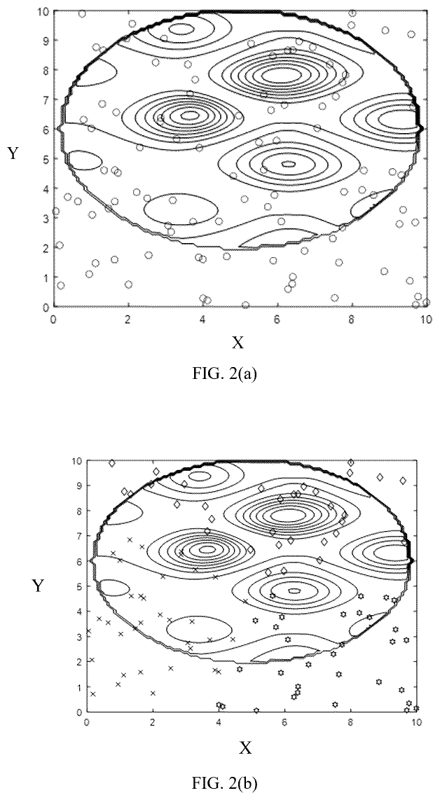

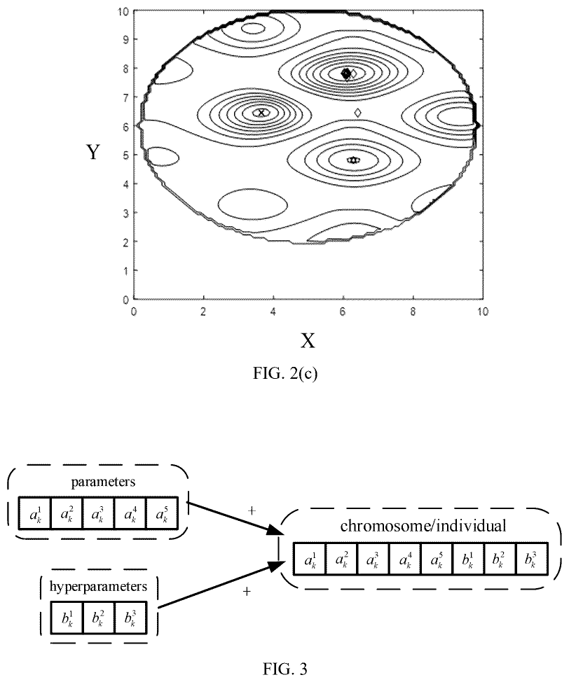

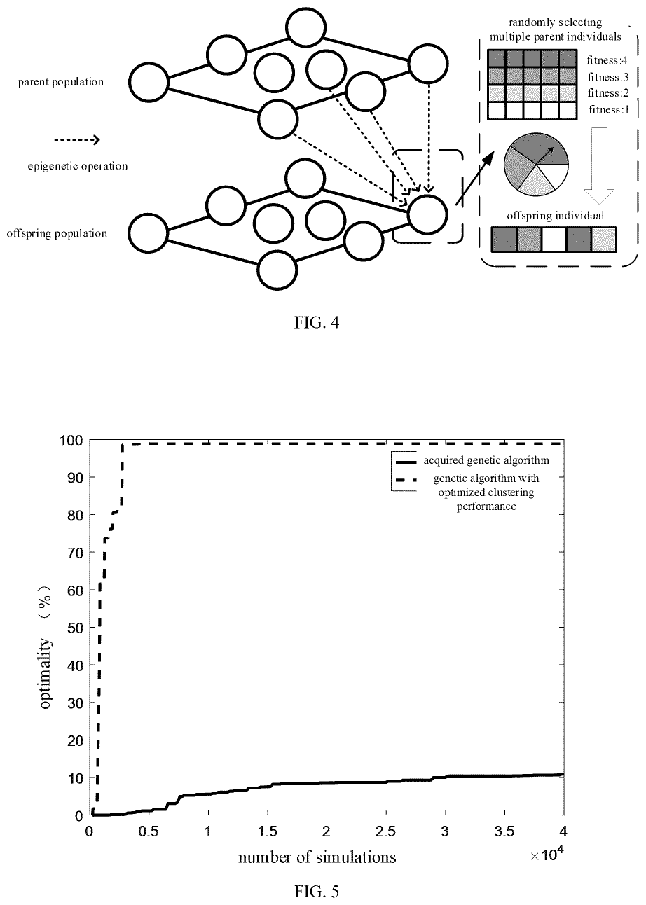

As shown in FIGS. 1-5, an intelligent arrangement method for array antenna elements, a J_K array refers to an L-shaped array antenna where numbers of elements in two adjacent boundary columns are J and K respectively, including:
S1. encoding the J_K array and initializing the epigenetic algorithm: treating the J_K array as a chromosome, when forming a genes of an individual, representing the J_K array using J+K randomly generated binary strings; wherein a number of bits of each binary string is Na, and each binary string is called a gene on a chromosome; each binary string represents an element spacing between a current element and a previous one, and J+K genes are generated using an above method;
S2. determining hyperparameters to be optimized and generating L hyperparameter genes;
S3. saving current J+K+L genes as an initial population of a genetic algorithm; for convenience of expression, denoting a total number of genes in the chromosome (J+K+L) as d, so d=J+K+L;
S4. denoting each chromosome as

$${P}_{k}^{i} ;$$

a gene string of consists of

$${P}_{k}^{i}$$

consists of

$$\{ {x}_{k}^{1} ( i ) , {x}_{k}^{2} ( i ) , … , {x}_{k}^{d} ( i ) \} ,$$

expressed as

$${P}_{k}^{i} = \{ {x}_{k}^{i} ( i ) , i = 1 , … , {N}_{G} , j = 1 , … , d \} , where {x}_{k}^{j} ( i )$$

represents a gene and j represents a sequence number of the gene in the chromosome; a population

$${G}_{k} = \{ {P}_{k}^{i} , i = 1 , 2 … , {N}_{G} \} ,$$

where k is a generation of population evolution, i is the sequence number of the chromosome in the population, and N_{G} is a population size;
S5. adjusting an initial population G once, then calculating a fitness of each chromosome

$${P}_{k}^{i}$$

in the population Fₖ to obtain Fᵢ;
S6. using a clustering algorithm to divide Gₖ into K different subpopulations, selecting an optimal individual from each subpopulation for adaptive learning, and updating the fitness;
S7. performing epigenetic operations to obtain an offspring

$${G}_{k}^{′} ;$$

S8. randomly selecting M parent individuals

$${P}_{k}^{i} = \{ {x}_{k}^{j} ( i ) , i = 1 , … , M , j = 1 , … d \} ,$$

and calculating a fitness proportion p of each parent as

$$p = \frac{{F}_{i}}{{\sum }_{i = 1}^{M} {F}_{i}} ;$$

setting j=1;
S9. the M parent individuals constructing a current gene pool

$${X}^{j} = \{ {x}_{k}^{j} ( 1 ) , {x}_{k}^{j} ( 2 ) , … , {x}_{k}^{j} ( M ) \} ;$$

S10. based on the fitness proportion p of each parent individual, selecting the gene

$${x}_{k}^{j} ( n ) , n ∈ [ 1 , M ]$$

using roulette selection, where individuals with higher proportions have a higher probability of their current genes being selected;
S11. writing

$${x}_{k}^{j} ( n )$$

into a corresponding gene position of the offspring \hat{P}ₖ;
S12. setting j=j+1;
S13. repeating steps S8˜S12 until j=d;
S14. generating an offspring individual

$${\hat{P}}_{k} = \{ {x}_{k}^{j} , j = 1 , … d \} ;$$

S15. repeating steps S8˜S14 N_{G} times to obtain a temporary new population Gk′;
S16. performing mutation operations according to a mutation probability pₘ to generate a new population Gₖ₊₁;
S17. calculating hyperparameter genes of each chromosome in the population Gₖ₊₁ to update the algorithm hyperparameters, and computing a fitness of an updated population;
S18. repeating iterative steps S6˜S17 until a preset termination condition is met, obtaining multiple optimal populations. The preset termination condition includes that the change in the fitness of the optimal individual does not exceed 10⁻⁶ and/or the preset maximum number of simulations is reached (e.g., 40,000 times). The optimal individual meets the preset gain requirement (Gain, e.g., 20 dB) or antenna aperture efficiency (e.g., 80%).
S19. according to different scenarios and requirements, outputting one required optimal population gene and decoding into an element arrangement of a L-shaped array antenna. The entire population is divided into different subpopulations, and the “different scenarios and requirements” include the main lobe gain of the antenna, antenna aperture efficiency, or corresponding beamwidth, etc.

Specifically, through the above embodiment: first, the J_K array of the L-shaped array antenna is encoded to randomly generate an initial population. Then the fitness value of each individual in the array population to be optimized is calculated. A clustering algorithm in machine learning is used to divide the population into subpopulations with different characteristics; some individuals in each category perform adaptive learning, and carry out inheritance operations based on epigenetics according to the probability of the fitness of the population individuals. Subsequently, a small number of random mutation operations is performed to generate new subpopulations. Algorithm hyperparameters such as population size and mutation probability participate in the evolution of individual genes and adaptively change according to the evolutionary state. The above operations iteratively are repeated until the preset stop condition is met, to obtain multiple optimal subpopulations. Then the user outputs the optimal element arrangement of the L-shaped array antenna according to different required application scenarios. The present application has prominent intelligent arrangement characteristics and significant progress in antenna performance, solving the problems of slow convergence speed and poor obtained results in the optimization process of the arrangement algorithm of the current L-shaped array antenna system, and is applicable to the element arrangement setting of L-shaped and other array antennas.

### Embodiment 2

In Embodiment 2 of the present application, the adjustment method for adjusting the initial population in step S5 is as follows:
converting the J+K binary strings of each generation into decimal numbers, a value of a decimal number obtained by converting the binary string corresponds to the element spacing between the current element and the previous one, that is, an element spacing D is obtained by restoring the binary string;
when calculating positions of first J elements, counting each generated element spacing D and accumulating to calculate an overall aperture value, if an accumulated value of the element spacing D is about to exceed a maximum array aperture Da, compulsorily adjusting the element spacing of subsequent elements to 1; and
the adjustment method for the latter K elements is the same as that for the first J elements.

### Embodiment 3

In Embodiment 3 of the present application, the maximum array aperture Da is 57˜65.

### Embodiment 4

In Embodiment 4 of the present application, an optimization method based on clustering epigenetics is provided, which includes the following steps:
A1. denoting a total number of genes in a chromosome (J+K+L) as d, so d=J+K+L;
A2. denoting each chromosome as

$${P}_{k}^{i} ;$$

a gene string of

$${P}_{k}^{i}$$

consists of

$$\{ {x}_{k}^{1} ( i ) , {x}_{k}^{2} ( i ) , … , {x}_{k}^{d} ( i ) \} ,$$

expressed as

$${P}_{k}^{i} = \{ {x}_{k}^{j} ( i ) , i = 1 , … , {N}_{G} , j = 1 , … d \} , where {x}_{k}^{j} ( i )$$

represents a gene and j represents a sequence number of the gene in the chromosome; a population

$${G}_{k} = \{ {P}_{k}^{i} , i = 1 , 2 … , {N}_{G} \} ,$$

where k is a generation of population evolution, i is the sequence number of the chromosome in the population, and N_{G} is a population size;
A3. adjusting an initial population Gₖ once, then calculating a fitness of each chromosome

$${P}_{k}^{i}$$

in the population Gₖ to obtain Fᵢ;
A4. using a clustering algorithm to divide Gₖ into K different subpopulations, selecting an optimal individual from each subpopulation for adaptive learning, and updating the fitness;
A5. performing epigenetic operations to obtain an offspring

$${G}_{k}^{′} ;$$

A6. randomly selecting M parent individuals

$${P}_{k}^{i} = \{ {x}_{k}^{j} ( i ) , i = 1 , … , M , j = 1 , … d \} ,$$

and calculating a fitness proportion p of each parent as

$$p = \frac{{F}_{i}}{{\sum }_{i = 1}^{M} {F}_{i}} ;$$

selling j=1,
A7. the M parent individuals constructing a current gene pool

$$\begin{matrix}{X}^{j} = \{ {x}_{k}^{j} ( 1 ) , \\ {x}_{k}^{j} ( 2 ) , … , {x}_{k}^{j} ( M ) \} ;\end{matrix}$$

A8. based on the fitness proportion p of each parent individual, selecting the gene

$${x}_{k}^{i} ( n ) , n ∈ [ 1 , M ]$$

using roulette selection, where individuals with higher proportions have a higher probability of their current genes being selected;
A9. writing

$${x}_{k}^{i} ( n )$$

into a corresponding gene position of the offspring \hat{P}ₖ;
A10. setting j=j+1;
A11. repeating steps A6˜A10 until j=d;
A12. generating an offspring individual

$${\hat{P}}_{k} = \{ {x}_{k}^{j} , j = 1 , … d \} ;$$

A13. repeating steps A6˜A12 N_{G} times to obtain a temporary new population Gk′;
A14. performing mutation operations according to a mutation probability pₘ to generate a new population Gₖ₊₁;
A15. calculating hyperparameter genes of each chromosome in the population Gₖ₊₁ to update the algorithm hyperparameters, and computing a fitness of an updated population; and
A16. repeating iterative steps A4˜A15 until a preset termination condition is met, obtaining multiple optimal populations.

The foregoing is merely a preferred embodiment of the present application and is not intended to limit the present application in any form. Although the present application is disclosed above with a preferred embodiment, it is not intended to limit the present application. Any person skilled in the art, without departing from the scope of the technical solution of the present application, may make slight changes or modifications to equivalent embodiments with equivalent changes by using the technical content disclosed above. However, any simple modifications, equivalent changes and modifications made to the above embodiments in accordance with the technical essence of the present application without departing from the content of the technical solution of the present application shall fall within the scope of the technical solution of the present application.

What is claimed is:

1. An intelligent arrangement method for array antenna elements, wherein a J_K array refers to an L-shaped array antenna where numbers of elements in two adjacent boundary columns are J and K respectively, the method comprises:
S1. encoding the J_K array and initializing the epigenetic algorithm: treating the J_K array as a chromosome, when forming a genes of an individual, representing the J_K array using J+K randomly generated binary strings; wherein a number of bits of each binary string is Na, and each binary string is called a gene on a chromosome; each binary string represents an element spacing between a current element and a previous one, and J+K genes are generated using an above method;
S2. determining hyperparameters to be optimized and generating L hyperparameter genes;
S3. saving current J+K+L genes as an initial population of a genetic algorithm; for convenience of expression, denoting a total number of genes in the chromosome (J+K+L) as d, so d=J+K+L;
S4. denoting each chromosome as
$${P}_{k}^{i} ;$$
a gene string of
$${P}_{k}^{i}$$
consists of
$$\{ {x}_{k}^{1} ( i ) , {x}_{k}^{2} ( i ) , … , {x}_{k}^{d} ( i ) \} ,$$
expressed as
$${P}_{k}^{i} = \{ {x}_{k}^{j} ( i ) , i = 1 , … , {N}_{G} , j = 1 , … d \} , where {x}_{k}^{j} ( i )$$
represents a gene and j represents a sequence number of the gene in the chromosome; a population
$${G}_{k} = \{ {P}_{k}^{i} , i = 1 , 2 … , {N}_{G} \} ,$$
where k is a generation of population evolution, i is the sequence number of the chromosome in the population, and N_{G} is a population size;
S5. adjusting an initial population Gₖ once, then calculating a fitness of each chromosome
$${P}_{k}^{i}$$
in the population Gₖ to obtain Fᵢ;
S6. using a clustering algorithm to divide Gₖ into K different subpopulations, selecting an optimal individual from each subpopulation for adaptive learning, and updating the fitness;
S7. performing epigenetic operations to obtain an offspring
$${G}_{k}^{′} ;$$
S8. randomly selecting M parent individuals
$${P}_{k}^{i} = \{ {x}_{k}^{j} ( i ) , i = 1 , … , M , j = 1 , … d \} ,$$
and calculating a fitness proportion p of each parent as
$$p = \frac{{F}_{i}}{{\sum }_{i = 1}^{M} {F}_{i}} ;$$
setting j=1;
S9. the M parent individuals constructing a current gene pool
$$\begin{matrix}{X}^{j} = \{ {x}_{k}^{j} ( 1 ) , \\ {x}_{k}^{j} ( 2 ) , … , {x}_{k}^{j} ( M ) \} ;\end{matrix}$$
S10. based on the fitness proportion p of each parent individual, selecting the gene
$${x}_{k}^{j} ( n ) , n ∈ [ 1 , M ]$$
using roulette selection, where individuals with higher proportions have a higher probability of their current genes being selected;
S11. writing
$${x}_{k}^{j} ( n )$$
into a corresponding gene position of the offspring \hat{P}ₖ;
S12. setting j=j+1;
S13. repeating steps S8˜S12 until j=d;
S14. generating an offspring individual
$${\hat{P}}_{k} = \{ {x}_{k}^{j} , j = 1 , … d \} ;$$
S15. repeating steps S8˜S14 N_{G} times to obtain a temporary new population Gk′;
S16. performing mutation operations according to a mutation probability pₘ to generate a new population Gₖ₊₁;
S17. calculating hyperparameter genes of each chromosome in the population Gₖ₊₁ to update the algorithm hyperparameters, and computing a fitness of an updated population;
S18. repeating iterative steps S6˜S17 until a preset termination condition is met, obtaining multiple optimal populations; and
S19. according to different scenarios and requirements, outputting one required optimal population gene and decoding into an element arrangement of a L-shaped array antenna.

2. The intelligent arrangement method for array antenna elements according to claim 1, wherein an adjustment in step S5 comprises converting binary strings into decimal numbers.

3. The intelligent arrangement method for array antenna elements according to claim 1, wherein the adjustment method for adjusting the initial population in step S5 is as follows:
converting the J+K binary strings of each generation into decimal numbers, a value of a decimal number obtained by converting the binary string corresponds to the element spacing between the current element and the previous one, that is, an element spacing D is obtained by restoring the binary string;
when calculating positions of first J elements, counting each generated element spacing D and accumulating to calculate an overall aperture value, if an accumulated value of the element spacing D is about to exceed a maximum array aperture Da, compulsorily adjusting the element spacing of subsequent elements to 1; and
the adjustment method for the latter K elements is the same as that for the first J elements.

4. The intelligent arrangement method for array antenna elements according to claim 3, wherein the maximum array aperture Da is 57˜65.

5. The intelligent arrangement method for array antenna elements according to claim 1, wherein the preset termination condition in step S18 comprises that a change in the fitness of the optimal individual does not exceed 10⁻⁶ and/or a preset maximum number of simulations is reached.

6. An optimization method based on clustering epigenetics, comprising:
A1. denoting a total number of genes in a chromosome (J+K+L) as d, so d=J+K+L;
A2. denoting each chromosome as
$${P}_{k}^{i} ;$$
a gene string of
$${P}_{k}^{i}$$
consists of
$$\{ {x}_{k}^{1} ( i ) , {x}_{k}^{2} ( i ) , … , {x}_{k}^{d} ( i ) \} ,$$
expressed as
$${P}_{k}^{i} = \{ {x}_{k}^{j} ( i ) , i = 1 , … , {N}_{G} , j = 1 , … d \} , where {x}_{k}^{j} ( i )$$
represents a gene and j represents a sequence number of the gene in the chromosome; a population
$${G}_{k} = \{ {P}_{k}^{i} , i = 1 , 2 … , {N}_{G} \} ,$$
where k is a generation of population evolution, i is the sequence number of the chromosome in the population, and N_{G} is a population size;
A3. adjusting an initial population Gₖ once, then calculating a fitness of each chromosome
$${P}_{k}^{i}$$
in the population Gₖ to obtain Fᵢ;
A4. using a clustering algorithm to divide Gₖ into K different subpopulations, selecting an optimal individual from each subpopulation for adaptive learning, and updating the fitness;
A5. performing epigenetic operations to obtain an offspring
$${G}_{k}^{′} ;$$
A6. randomly selecting M parent individuals
$${P}_{k}^{i} = \{ {x}_{k}^{j} ( i ) , i = 1 , … , M , j = 1 , … d \} ,$$
and calculating a fitness proportion p of each parent as
$$p = \frac{{F}_{i}}{{\sum }_{i = 1}^{M} {F}_{i}} ;$$
setting j=1;
A7. the M parent individuals constructing a current gene pool
$${X}^{j} = \{ {x}_{k}^{j} ( 1 ) , {x}_{k}^{j} ( 2 ) , … , {x}_{k}^{j} ( M ) \} ;$$
A8. based on the fitness proportion p of each parent individual, selecting the gene
$${x}_{k}^{j} ( n ) , n ∈ [ 1 , M ]$$
using roulette selection, where individuals with higher proportions have a higher probability of their current genes being selected;
A9. writing
$${x}_{k}^{j} ( n )$$
into a corresponding gene position of the offspring \hat{P}ₖ;
A10. setting j=j+1;
A11. repeating steps A6˜A10 until j=d;
A12. generating an offspring individual
$${\hat{P}}_{k} = \{ {x}_{k}^{j} , j = 1 , … d \} ;$$
A13. repeating steps A6˜A12 N_{G} times to obtain a temporary new population Gk′;
A14. performing mutation operations according to a mutation probability pₘ to generate a new population Gₖ₊₁;
A15. calculating hyperparameter genes of each chromosome in the population Gₖ₊₁ to update the algorithm hyperparameters, and computing a fitness of an updated population; and
A16. repeating iterative steps A4˜A15 until a preset termination condition is met, obtaining multiple optimal populations.
